(19) United States
(12) Patent Application Publication
(10) Pub. No.: US 2010/0115232 A1
(43) Pub. Date: May 6, 2010

(54) LARGE INTEGER SUPPORT IN VECTOR OPERATIONS

(76) Inventors: Timothy J. Johnson, Chippewa Falls, WI (US); Eric P. Lundberg, Chippewa Falls, WI (US); Michael Parker, Chippewa Falls, WI (US); Gregory J. Faanes, Chippewa Falls, WI (US)

Correspondence Address: SCHWEGMAN, LUNDBERG & WOESSNER, P.A., P.O. BOX 2938, MINNEAPOLIS, MN, 55402, US

(21) Appl. No.: 12/263,313

(22) Filed: Oct. 31, 2008

(51) Int. Cl. G06F 9/302; G06F 15/76

(52) U.S. Cl. 712/4; 712/222; 712/E09.017; 712/4; 712/E09.003; 712/E09.024

(57) ABSTRACT

A vector processor or vector processing computer has a first vector register operable to store two or more vector elements that together comprise a single first large integer and a second vector register operable to store two or more vector elements that together comprise a single second large integer. An adder having a carry-in bit is operable to add the large integer in the first vector register to the large integer in the second vector register by using the carry-in bit to add sequential elements of the vector registers.

### FIELD OF THE INVENTION

The invention relates generally to vector computer processors, and more specifically in one embodiment to large integer support in vector computer processor.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

In more sophisticated computer systems, multiple processors are used, and one or more processors runs software that is operable to assign tasks to other processors or to split up a task so that it can be worked on by multiple processors at the same time. In such systems, the data being worked on is typically stored in memory that is either centralized, or is split up among the different processors working on a task.

Instructions from the instruction set of the computer's processor or processor that are chosen to perform a certain task form a software program that can be executed on the computer system. Typically, the software program is first written in a high-level language such as “C” that is easier for a programmer to understand than the processor's instruction set, and a program called a compiler converts the high-level language program code to processor-specific instructions.

In multiprocessor systems, the programmer or the compiler will usually look for tasks that can be performed in parallel, such as calculations where the data used to perform a first calculation are not dependent on the results of certain other calculations such that the first calculation and other calculations can be performed at the same time. The calculations performed at the same time are said to be performed in parallel, and can result in significantly faster execution of the program. Although some programs such as web browsers and word processors don't consume a high percentage of even a single processor's resources and don't have many operations that can be performed in parallel, other operations such as scientific simulation can often run hundreds or thousands of times faster in computers with thousands of parallel processing nodes available.

Multiple operations can also be performed at the same time using one or more vector processors, which perform an operation on multiple data elements at the same time. For example, rather than instruction that adds two numbers together to produce a third number, a vector instruction may add elements from a 64-element vector to elements from a second 64-element vector to produce a third 64-element vector, where each element of the third vector is the sum of the corresponding elements in the first and second vectors.

In this example, the vector registers each hold 64 elements, so the vector length is said to be 64. The vector processor can handle sets of data smaller than 64 by using a vector length register specifying that some number fewer than 64 elements are to be processed, or can handle sets of data larger than 64 elements by using multiple vector operations to process all elements in the data set, such as by using a program loop.

Vectors are often used for applications such as scientific or simulation applications, such as where each element in the vector is a number representing an element of some system being simulated. For example, weather simulation may use large arrays of integers representing temperature, pressure, and wind speed data at different points in space to perform simulation. The size of each piece of digital information in scalar and vector processors is known as a word, which is typically a specific number of bits used to encode a number, a letter, a symbol, a software program instruction, or other information needed to execute various applications on the computer system. Computer words include program instructions as well as data, which can vary significantly by application—a word processor or text editor may use many data words to represent letters, numbers, and printed symbols, while a scientific computing simulation program such as the weather prediction example discussed earlier may use almost entirely integers or floating point numbers.

It is desired that computers be able to handle data types needed for various applications to execute the applications efficiently.

### SUMMARY

Some embodiments of the invention comprise a vector processor or vector processing computer having a first vector register operable to store two or more vector elements that together comprise a single first large integer and a second vector register operable to store two or more vector elements that together comprise a single second large integer. An adder having a carry-in bit is operable to add the large integer in the first vector register to the large integer in the second vector register by using the carry-in bit to add sequential elements of the vector registers.

### BRIEF DESCRIPTION OF THE FIGURES

FIG. 1 shows an adder, as may be used to practice some embodiments of the invention.

FIG. 2 shows an adder having a carry-in bit and carry-out bit, consistent with an example embodiment of the invention.

FIG. 3 shows a vector processor having vector registers and one or more functional units operable to provide large integer functionality, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or applications. Other embodiments of the invention exist and are within the scope of the invention, and logical, mechanical, electrical, and other changes may be made without departing from the scope or subject of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

In some embodiments of the invention, a vector processor or vector processing computer operable to use vector hardware to provide large integer functionality has a first vector register operable to store two or more vector elements that together comprise a single first large integer and a second vector register operable to store two or more vector elements that together comprise a single second large integer. An adder having a carry-in bit is operable to add the large integer in the first vector register to the large integer in the second vector register by using the carry-in bit to add sequential elements of the vector registers.

Vector processor architectures often include vector registers having a fixed number of entries, each vector register capable of holding a single vector. Vector functional units, such as an add/subtract unit, a multiply unit and a divide unit, and logic operation units are either dedicated to serving vector operations or are shared with scalar operations. Scalar registers are also used in some vector operations, such as where every element of a vector is multiplied by a scalar number. An example processor might have, for example, eight vector registers with 64 elements per register, where each element is a 64-bit word.

This works well for applications in which traditional fixed-length words are appropriate for the type of application or data being processed in the computer system. But, certain programs such as cryptography and other security applications often deal with very large pieces of data, such as 256-bit or larger encryption keys and relatively large data words. Although typical 32-bit personal computers and higher performance 64-bit computers can process these very large data words, they typically do so by performing a series of 32-bit or 64-bit operations in the native word size of the computer, and performing additional operations to combine the results of individual operations into the large word sized result.

The individual operations required to perform large word size operations take significantly more time than a single operation in a computer's native word size, and result in significantly slower program operation. The present invention provides in one example embodiment a solution to this problem, providing support in a vector processor for large integers by providing added features such as a carry bit and additional functional units where needed to enable processing two or more words of a vector as a large integer.

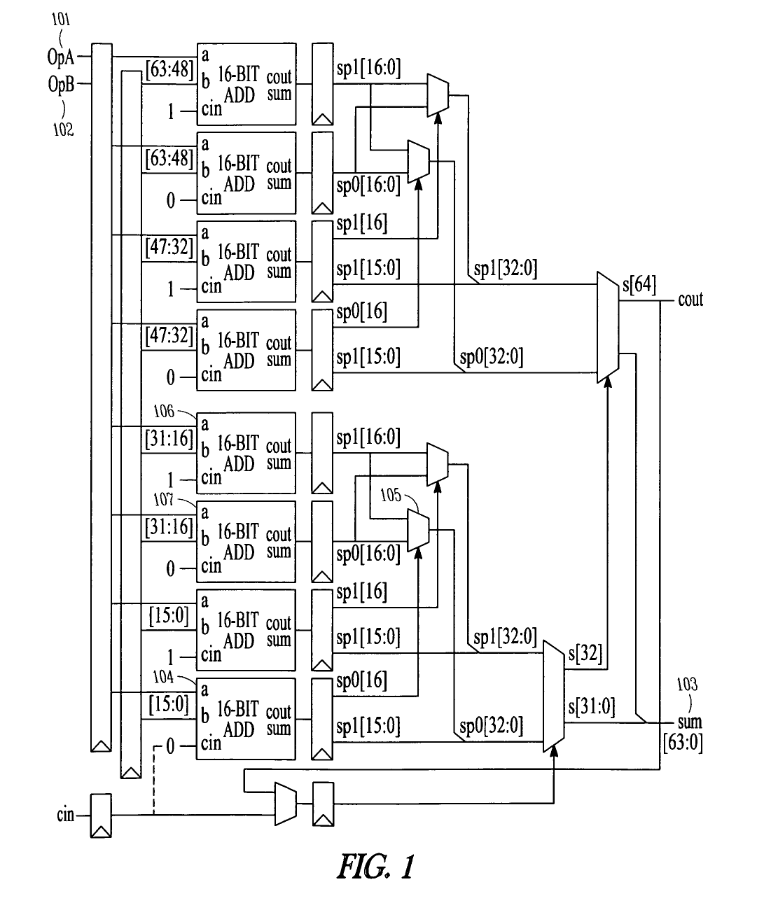

FIG. 1 is a block diagram of an example 64-bit integer adder, as may be used to practice some embodiments of the invention. The 64-bit adder adds operands A and B, identified as OpA 101 and OpB 102 in the diagram, providing a result as a 64-bit Sum 103. The adder comprises a series of 16-bit adders coupled to one another, such that the individual 16-bit segments of the two 64-bit words are added together and carry bits are forwarded between adder results to create a 64-bit sum from the two 64-bit input words.

The bottom 16-bit adder 104 simply adds bits 0 though 15 of the two input words OpA and OpB, and provides the output into a latch. The bits 0-15 are forwarded to a multiplexer, where they are combined with higher-order bits to produce the 64-bit output word. The higher-order bit adders are not single adders for ach 16-bit grouping, but includes two adders per 16-bit element. The pair of adders calculate the sum in parallel—one adder calculating the result with a carry bit received from the immediately lower-order bit adder, and the other calculating without a carry bit. Both are calculated because it is not known whether the carry bit will or will not be set until the lower-order bit addition is completed, and it is desirable to complete all the 16-bit additions in parallel rather than wait for results of lower-order bit addition to calculate higher-order bit addition. Multiplexer 106 uses the carry bit from adder 104 to choose whether to use the addition result from adder 106, including a carry bit, or adder 107, with no carry bit, to choose the desired output.

The higher-order bits 32-47 and 48-63 are similarly added both with and without carry bits, and multiplexers are used to select the result. This allows all 16-bit adders such as 104, 106, and 107 to operate in parallel, rather than wait for the results from lower-order bit adders to produce the 64-bit output sum.

Such an adder works well for applications in which 64-bit words are sufficient to handle the desired data type, including many typical floating point and integer applications such as scientific computing and simulation. But, a small number of specific applications operate using very large data element sizes, and a 64-bit adder is not able to operate on an entire piece of data at a time. One example is cryptography, which often uses elements that are 256 to 1024 bits or larger in size. Although the very large size of each element is desirable in some applications such as using large encryption keys to ensure the security of the encryption algorithm, a 64-bit adder in a 64-bit computer is not able to perform functions such as adding a 1024-bit encryption element to another 1024-bit word in a single operation.

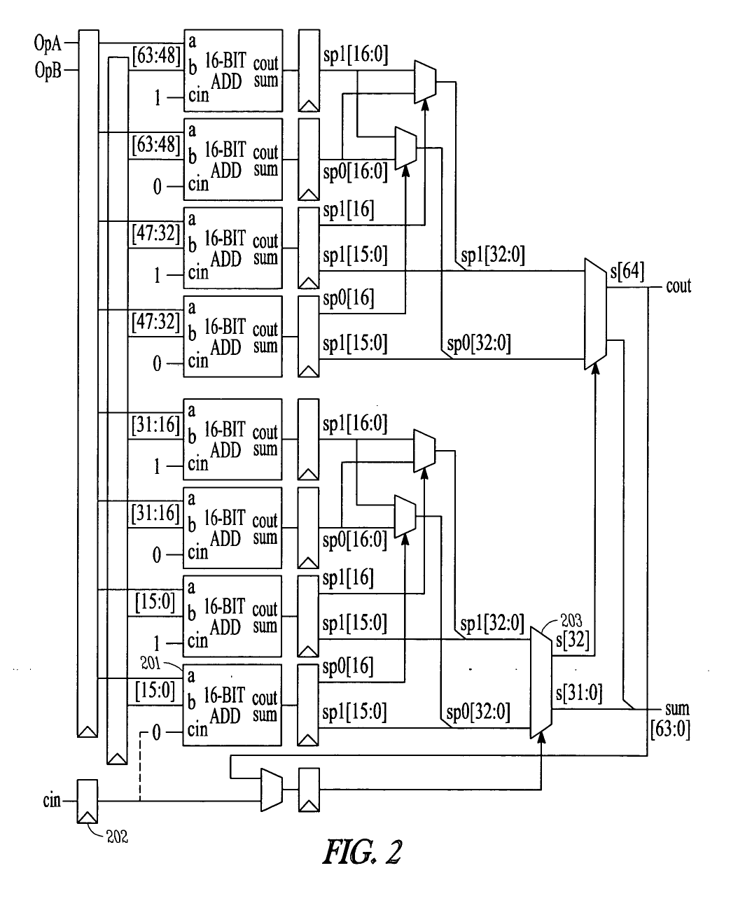

FIG. 2 shows a modified block diagram of an example 64-bit integer adder, as may be used to practice some embodiments of the invention. Here, an additional 16-bit adder 201 is added to the adder of FIG. 1, operable to calculate a 16-bit sum of the 16 least significant bits of a 64-bit word including a carry bit of one. While a normal addition function applied to two 64-bit words would never have a carry bit applied to the least significant bits of the numbers being added, the modified adder of FIG. 2 enables chaining multiple adders together or using them in other sequences or configurations to operate on much larger word sizes in hardware.

In this example, the 64-bit integer adder of FIG. 2 receives a carry in bit 202, which is latched and provided to a multiplexer to select whether the result of the zero-carry 16-bit adder should be used, or the one-carry 16-bit adder 201 should be used to calculate the least significant bits. If a carry bit is applied, the least significant bits in the 64-bit adder are not the least significant bits of the overall numbers being added, but are the least significant bits of another 64-bit segment of the numbers being added. For example, if adding two 1024-bit data elements in a cryptography operation, the adder of FIG. 2 may be used to add any of 16 different 64-bit segments of the 1024-bit elements.

In a further embodiment, the 64-bit adders used to provide support for large integer operations are operable to add integers significantly larger than 64 bits by using vector processing capability along with an adder such as that of FIG. 2 to add sequential 64-bit segments of large integers stored as a vector in sequential clock cycles. A traditional add instruction goes through many phases before it is executed, including fetching and decoding the instruction, accessing memory to load whatever data might be needed for the instruction, executing the instruction, and storing the result to memory. In an embodiment of the present invention, a vector register and vector operations are used along with a modified functional unit such as the adder of FIG. 2 to us a single executed instruction to operate on several elements in a vector register, performing large integer operations using a single instruction.

For example, a 64-bit vector processor using 64-bit words and having 16 elements per vector register, a large integer add instruction can be performed on integers up to 1024 bits in size (16 elements*64-bit words=1024 bit large integer). A typical instruction might add the contents of a first vector register to the contents of a second vector register, treating the entire contents of each register as a single large integer word using the carry bit architecture of FIG. 2, and store the result of the add in one of the two vector registers. Although the actual adding of the two 1024-bit large integer words happens in 64-bit chunks as each 64-bit segment of the 1024-bit word are processed sequentially through the adder of FIG. 2, only a single instruction needs to be processed in the instruction pipeline to perform the large integer add operation. This eliminates the need for multiple instructions to make their way through the processor to add each segment, add and store carry bits, and execute other instructions that may be needed to calculate a large integer add result.

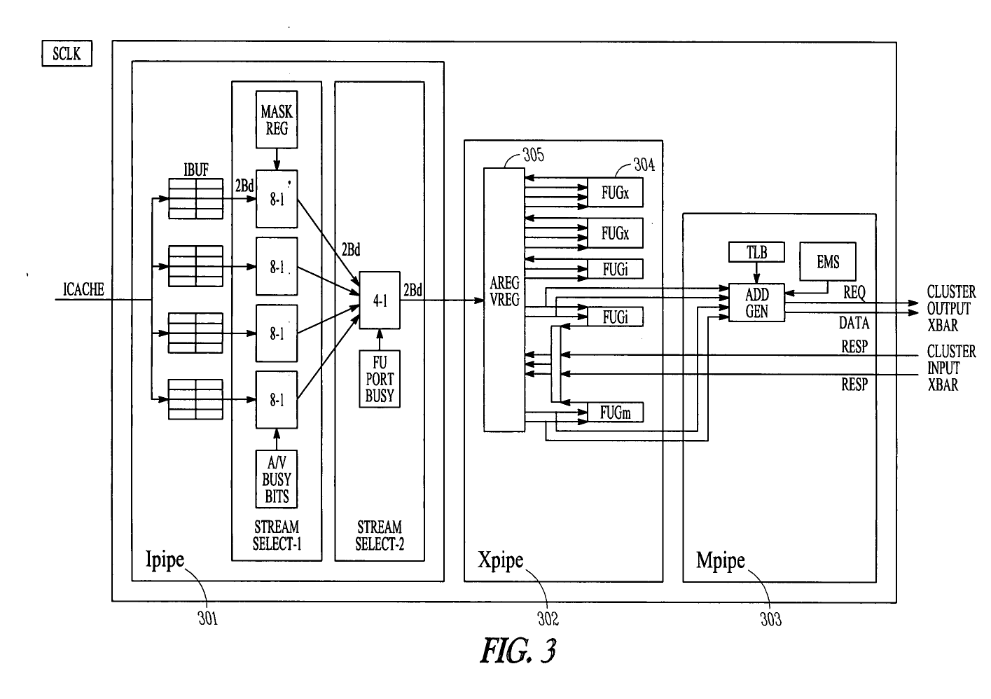

FIG. 3 is a block diagram of a computer processor, consistent with an example embodiment of the invention. The processor comprises three main parts; an instruction fetch and issue pipeline Ipipe 301, an instruction execution pipeline Xpipe 302, and a memory load/store pipeline Mpipe 303. The instruction execution pipeline Xpipe 302 includes various functional units such as functional unit group FUGx 304 that is operable to perform various floating point and integer math functions, and integer math functional unit group FUGi. A register file including vector registers and address registers 305 is coupled to the various functional units, and holds the data upon which the functional units execute instructions.

The FUGx functional unit group here includes the large integer support adder of FIG. 2, and is operable to perform large integer addition on large integers stored in the vector register 305. To calculate the result of adding two 1024-bit integers, for example, each 1024 bit word is loaded into one of the vector registers 305, broken up into 16 separate 64-bit segments. The 64-bit segments are processed sequentially in an adder such as that of FIG. 2, but the 16 different segments are processed as the result of a single vector instruction. The 16 segments are also processed sequentially, from least significant bits to most significant bits, so that the carry bit from each of the 64-bit addition calculations can be passed on to the next higher bit-order 64-bit addition.

The examples presented here have shown how a vector processor and vector registers can be used to provide large integer support for specialized applications such as cryptography that benefit from handling data larger than a computer's architectural word size. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A vector processor, comprising:
a first vector register operable to store two or more vector elements that together comprise a single first large integer;
a second vector register operable to store two or more vector elements that together comprise a single second large integer
an adder, comprising a carry-in bit, the adder operable to add the large integer in the first vector register to the large integer in the second vector register by using the carry-in bit to add sequential elements of the vector registers.

2. The vector processor of claim 1, wherein the carry-in bit is conveyed from a lower-order bit add operation to a sequential higher-order bit add operation to enable sequential addition of vector elements to calculate the sum of the first and second large integers.

3. The vector processor of claim 2, further comprising a register operable to store the carry-in bit.

4. The vector processor of claim 1, wherein the adder comprises a plurality of smaller adders having a bit size smaller than the vector element size; one or more of the smaller adders comprising a carry in bit or a carry out bit.

5. The vector processor of claim 4, wherein one or more of the plurality of smaller adders comprise two adders for the range of bits to be added, the two adders comprising an adder assuming a carry in of one and an adder assuming a carry in of zero.

6. The vector processor of claim 5, further comprising one or more multiplexers operable to use one or more carry bits to select a sum from the adder assuming a carry in of one or the adder assuming a carry in of zero for the range of bits to be added.

7. The vector processor of claim 1, the adder operable to add an arbitrary portion of a word having a larger size than the adder word size by using one or more carry in or carry out bits.

8. A computer system, comprising:
a first vector register operable to store two or more vector elements that together comprise a single first large integer;
a second vector register operable to store two or more vector elements that together comprise a single second large integer
an adder, comprising a carry-in bit, the adder operable to add the large integer in the first vector register to the large integer in the second vector register by using the carry-in bit to add sequential elements of the vector registers.

9. The computer system of claim 8, wherein the carry-in bit is conveyed from a lower-order bit add operation to a sequential higher-order bit add operation to enable sequential addition of vector elements to calculate the sum of the first and second large integers.

10. The computer system of claim 9, further comprising a register operable to store the carry-in bit.

11. The computer system of claim 8, wherein the adder comprises a plurality of smaller adders having a bit size smaller than the vector element size; one or more of the smaller adders comprising a carry in bit or a carry out bit.

12. The computer system of claim 11, wherein one or more of the plurality of smaller adders comprise two adders for the range of bits to be added, the two adders comprising an adder assuming a carry in of one and an adder assuming a carry in of zero.

13. The computer system of claim 12, further comprising one or more multiplexers operable to use one or more carry bits to select a sum from the adder assuming a carry in of one or the adder assuming a carry in of zero for the range of bits to be added.

14. The computer system of claim 8, the adder operable to add an arbitrary portion of a word having a larger size than the adder word size by using one or more carry in or carry out bits.

15. A method of operating a vector computer processor system, comprising:
storing two or more vector elements that together comprise a single first large integer in a first vector register;
storing two or more vector elements that together comprise a single second large integer in a second vector register; and
adding the large integer in the first vector register to the large integer in the second vector register by using a carry-in bit to add sequential elements of the vector registers.

16. The method of operating a vector computer processor system of claim 15, further comprising conveying the carry-in bit from a lower-order bit add operation to a sequential higher-order bit add operation to enable sequential addition of vector elements to calculate the sum of the first and second large integers.

17. The method of operating a vector computer processor system of claim 15, wherein the adder comprises a plurality of smaller adders having a bit size smaller than the vector element size; one or more of the smaller adders comprising a carry in bit or a carry out bit; and

18. the method of operating a vector computer processor system of claim 17, wherein one or more of the plurality of smaller adders comprise two adders for the range of bits to be added, the two adders comprising an adder assuming a carry in of one and an adder assuming a carry in of zero.

19. The method of operating a vector computer processor system of claim 18, further comprising using one or more carry bits in a multiplexer to select a sum from the adder assuming a carry in of one or the adder assuming a carry in of zero for the range of bits to be added.

20. The method of operating a vector computer processor system of claim 15, the adder operable to add an arbitrary portion of a word having a larger size than the adder word size by using one or more carry in or carry out bits.

21. A vector processor, comprising a functional unit operable to perform computation on two or more vector elements in a vector as a single large integer.

22. A method of operating a vector computer processor, comprising performing computation on two or more vector elements in a vector as a single large integer.
